(19) United States
(12) Patent Application Publication
(10) Pub. No.: US 2021/0173878 A1
(43) Pub. Date: Jun. 10, 2021

(54) SYSTEMS AND METHODS OF INCREMENTED AGGREGATED DATA RETRIEVAL

(71) Applicant: salesforce.com, inc., San Francisco, CA (US)

(72) Inventor: Philippe Riand, Burlington, MA (US)

(21) Appl. No.: 16/707,417

(22) Filed: Dec. 9, 2019

(51) Int. Cl. G06F 16/951

(52) U.S. Cl. CPC G06F 16/951

(57) ABSTRACT

Systems and methods are provided for receiving, at a server, a request for data from a plurality of services. The server may receive a first portion of the data that is available from at least one of the plurality of services at a first time, and may transmit the received first portion of data via a communications network. The server may receive a second portion of the data of the data that is newly available from at least one of the plurality of services at a second time that is different from the first time, and may transmit the received second portion of data via the communications network. The requested data from the plurality of services may be provided in separate portions to be processed as the requested data becomes available.

### BACKGROUND

Current client-server systems typically have a server collect all service responses together before returning a service response to a client. Other current systems have the server provide a single result to the client for a single service request.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description explain the principles of implementations of the disclosed subject matter. No attempt is made to show structural details in more detail than can be necessary for a fundamental understanding of the disclosed subject matter and various ways in which it can be practiced.

FIG. 1 shows an example method of incremental aggregated data retrieval according to an implementation of the disclosed subject matter.

FIG. 2 shows an example method of processing received incremental data according to an implementation of the disclosed subject matter.

FIG. 3 shows a computer system according to an implementation of the disclosed subject matter.

FIG. 4 shows a network configuration according to an implementation of the disclosed subject matter.

### DETAILED DESCRIPTION

Various aspects or features of this disclosure are described with reference to the drawings, wherein like reference numerals are used to refer to like elements throughout. In this specification, numerous details are set forth in order to provide a thorough understanding of this disclosure. It should be understood, however, that certain aspects of disclosure can be practiced without these specific details, or with other methods, components, materials, or the like. In other instances, well-known structures and devices are shown in block diagram form to facilitate describing the subject disclosure.

Implementations of the disclosed subject matter provide systems and methods of splitting a service response returned by a server into chunks, as data becomes available. The initial object may include immediately available data, and subsequent datasets may provide the remaining data, as the data becomes available. The subsequent dataset may either be the data of the one or more previous responses along with the newly available data (i.e., the old data plus the newly available data), or just the newly available data.

When a platform is implemented using micro-services, applications typically use APIs (Application Program Interfaces) to aggregate data from multiple services. Micro-services may be an arrangement of an application as a collection of loosely coupled services. The response time for such services is typically the response time of the slowest micro-service they connect to, or the sum of all the response times (when invoked sequentially).

That is, some current systems have a server collect all of the service responses together before returning a service response to a client. This creates time delays, as all of the responses need to be available to the server before the service response may be sent to the client. Thus, the time needed to provide the service responses may be the response time of the slowest micro-service. Other current systems have a server provide a single result for a single service request. This may be inefficient when there are multiple service requests made sequentially (as the time needed to process the requests may be the sum of all of the response times for the requests). Some current systems may be a combination of the aforementioned systems, where a full aggregation of requests are split into a plurality of aggregated sub-requests. Such systems may have the caller (i.e., the device transmitting the request to the server) determine the status and/or performance of one or more services provided by the server, which may change over time.

Implementations of the disclosed subject matter reduce the processing delay by providing portions of data by services to a client device as they become available, so that the client device may process the available portions.

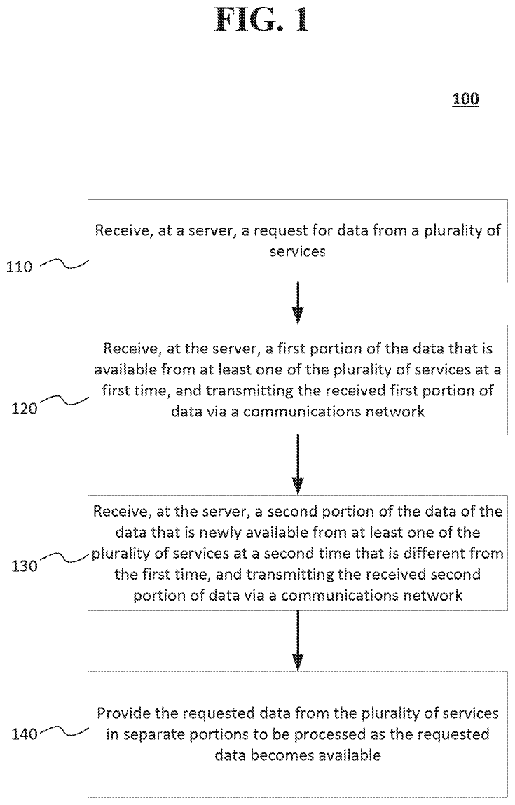

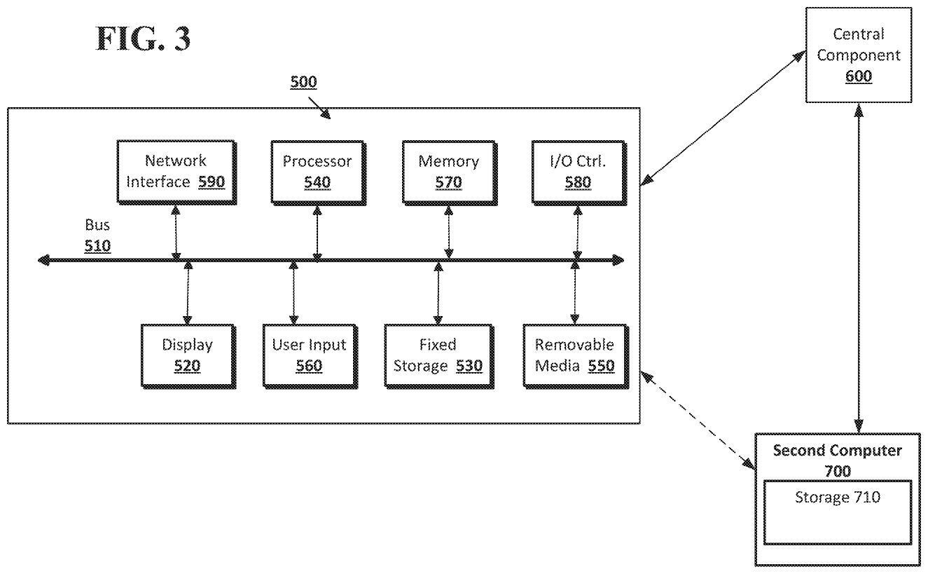

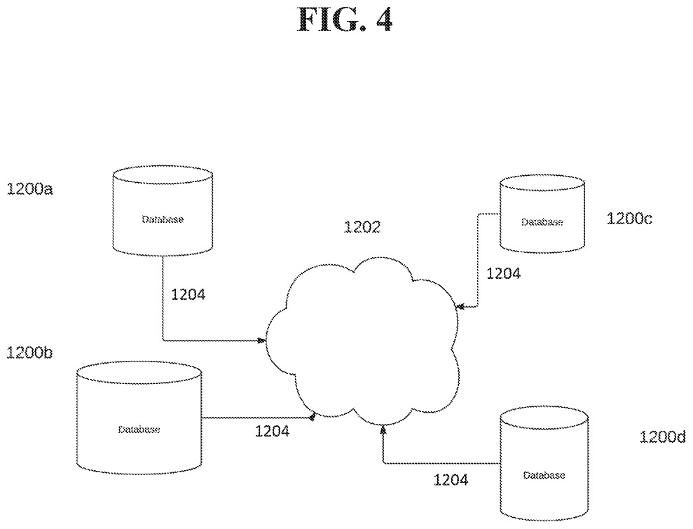

FIG. 1 shows an example method 100 for incremental aggregated data retrieval according to an implementation of the disclosed subject matter. At operation 110, a server (e.g., central component 600 and/or second computer 700 shown in FIG. 3, and/or database systems 1200a-d shown in FIG. 4) may receive a request for data from a plurality of services. The request may be received, for example, from computer 500 shown in FIG. 3.

For example, one or more of the plurality of services may include REST (Representational State Transfer) services, which may provide interoperability between computer systems communicatively coupled via a communications network. REST web services may allow the requesting systems (e.g., computer 500 shown in FIG. 3) to access and manipulate textual representations of web resources by using a uniform and predefined set of stateless operations. The REST web services may be provided, for example, by central component 600 and/or second computer 700 shown in FIG. 3, and/or database systems 1200a-d shown in FIG. 4.

At operation 120, the server may receive a first portion of the data that is available from at least one of the plurality of services at a first time. The server may transmit the received first portion of data via a communications network. In some implementations, an initial JSON (Javascript™ Object Notation) object received by the server may include immediately available data, which may be transmitted to the computer that issued the request. For example, the central component 600 and/or second computer 700 shown in FIG. 3 may transmit the first portion of data to the computer 500 shown in FIG. 3, which may have issued the request.

At operation 130, the server may receive a second portion of the data that is newly available from at least one of the plurality of services at a second time that is different from the first time. The second and/or subsequent portions of data may be referred to as a patch. For example, one or more subsequent JSON objects may be received by the server that include subsequently available data (i.e., data available after an initial JSON object is received). In some implementations, the patch may be made of a location (e.g., a JSON path or the like) where the data is to be received (e.g., a portion of memory 570 of computer 500 shown in FIG. 3), and the newly available JSON data may be provided to and/or injected at the location.

In some implementations, the transmitting the received second portion of data may include transmitting the received first portion of data and the received second portion of data as part of the same response. For example, the both the initial data and the subsequent data (i.e., patches) may be returned to the server within the same response.

At operation 140, the server may transmit the received second portion of data via the communications network, where the requested data from the plurality of services is provided in separate portions to be processed as the requested data becomes available.

That is, the retrieved data may be retrieved and/or composed asynchronously, and may be returned as a data fragment in the response to a query. The delayed behavior may be enabled for a client device (e.g., computer 500 shown in FIG. 3), which may be determined through an accept-content header, and/or any other parameter (e.g., HTTP (hypertext transfer protocol) header, uniform resource locator (URL) parameter, and the like). That is, the accept-content header, parameter, or the like for the data transmission may indicate that the data provided may be a fragment of the requested data, and that subsequent data may be provided.

Whether the server receives the second and/or subsequent portions of data, or receives both first portion of data and the received second portion of data as part of the same response, the server may provide (i.e., flush) a partial response, while the client device (e.g., computer 500 shown in FIG. 3) may parse the data received from the server incrementally, without waiting until all of the data is received.

In some implementations, the data may be provided (e.g., to the server and/or the client device) as a MIME (Multipurpose Internet Mail Extension) response with an initial entry, and with subsequent entries for each patch. In some implementations, the response may adhere to a W3C (World Wide Web Consortium) standard. In some implementations, the response may be in a predetermined and/or proprietary format, where the client device (e.g., computer 500 shown in FIG. 3) may be configured to process it.

In an example, a product detail page (PDP) provided by the server may include product-related data received from one or more services. The product description and/or the product image may be received and/or retrieved by the server from a database (e.g., database 1200a-1200d shown in FIG. 4). A price of the product may be determined by a service, based on one or more promotions, coupons, incentives, or the like. Product inventory information may be received and/or retrieved from one or more services. These services may provide data to the server at a rate that is slower than the data retrieved from the database (e.g., the product description and/or the product image). Using the systems and methods disclosed throughout, the server, may provide at least a portion of a content page of a website for a product catalog based on the available information, and the price and/or inventory may be provided on the webpage when such data becomes available from the one or more services.

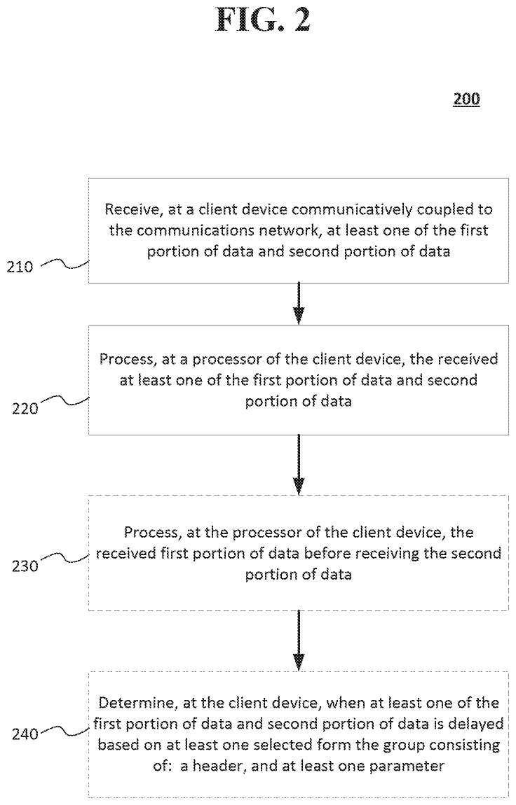

FIG. 2 shows an example method 200 that may be implemented at a client device (e.g., computer 500 shown in FIG. 3) that may be communicatively coupled to the server (e.g., implementing the method 100 of FIG. 1 according to an implementation of the disclosed subject matter. In the method 200, a client device may transmit a request with a delayed behavior instruction, such as an accept-content header, parameter, or the like that may indicate that the data provided may be a fragment of the requested data, and that subsequent data may be provided.

At operation 210, the client device may receive, via the communications network, at least one of the first portion of data and second portion of data. A processor (e.g., processor 540, shown in FIG. 3) of the client device may process the received at least one of the first portion of data and second portion of data at operation 220. In some implementations, the processor of the client device may process the received first portion of data before receiving the second portion of data at optional operation 230. In some implementations, the client device may determine when at least one of the first portion of data and second portion of data is delayed based on a header and/or at least one parameter at optional operation 240.

In some implementations, such as those described above in connection with FIGS. 1-2, the server may provide a partial response, while the client device may parse this response from the server incrementally, without waiting for the complete response. The data may be returned as a response with an initial entry, and may provide subsequent transmissions when data becomes available.

Implementations of the disclosed subject matter, such as those described in connection with FIGS. 1-2, may be used with data query and manipulation language for APIs, which also provide runtime for fulfilling queries with existing data, such as GraphQL or the like. This may allow client devices to define the structure of the data requested, and the same structure of the data may be returned from the server. This may minimize and/or prevent data quantities that exceed a predetermined amount of being returned from the server to the client device. This may prevent the client device from being overloaded with the data return request, so that it may operate as normal. When implementations of the disclosed subject matter are used with data query and manipulation language for APIs, a resolver that is used to retrieve data may be marked as delayed when not all of the data to be retrieved is available. The retriever may maintain the delayed status until a last portion of the data becomes available and is retrieved. The data may be provided asynchronously, where data is returned as data fragments in a response to queries.

Implementations of the presently disclosed subject matter may be implemented in and used with a variety of component and network architectures. FIG. 3 is an example computer 500 suitable for implementing implementations of the presently disclosed subject matter. As discussed in further detail herein, the computer 500 may be a single computer in a network of multiple computers. In some implementations, the computer 500 may be used to request data from one or more services, and/or processing received incremental data. As shown in FIG. 4, the computer 500 may communicate with a central or distributed component 600 (e.g., server, cloud server, database, cluster, application server, neural network system, or the like). The central component 600 may communicate with one or more other computers such as the second computer 700, which may include a storage device 710. The storage 710 may use any suitable combination of any suitable volatile and non-volatile physical storage mediums, including, for example, hard disk drives, solid state drives, optical media, flash memory, tape drives, registers, and random access memory, or the like, or any combination thereof.

The storage 710 of the second computer 700 can store data (e.g., data for one or more services to be retrieved in response to a query, or the like). Further, if the systems shown in FIGS. 3-4 are multitenant systems, the storage can be organized into separate log structured merge trees for each instance of a database for a tenant. Alternatively, contents of all records on a particular server or system can be stored within a single log structured merge tree, in which case unique tenant identifiers associated with versions of records can be used to distinguish between data for each tenant as disclosed herein. More recent transactions can be stored at the highest or top level of the tree and older transactions can be stored at lower levels of the tree. Alternatively, the most recent transaction or version for each record (i.e., contents of each record) can be stored at the highest level of the tree and prior versions or prior transactions at lower levels of the tree.

The information obtained to and/or from a central component 600 can be isolated for each computer such that computer 500 cannot share information with central component 600 (e.g., for security and/or testing purposes). Alternatively, or in addition, computer 500 can communicate directly with the second computer 700.

The computer (e.g., user computer, enterprise computer, or the like) 500 may include a bus 510 which interconnects major components of the computer 500, such as a central processor 540, a memory 570 (typically RAM, but which can also include ROM, flash RAM, or the like), an input/output controller 580, a user display 520, such as a display or touch screen via a display adapter, a user input interface 560, which may include one or more controllers and associated user input or devices such as a keyboard, mouse, Wi-Fi/cellular radios, touchscreen, microphone/speakers and the like, and may be communicatively coupled to the I/O controller 580, fixed storage 530, such as a hard drive, flash storage, Fibre Channel network, SAN device, SCSI device, and the like, and a removable media component 550 operative to control and receive an optical disk, flash drive, and the like.

The bus 510 may enable data communication between the central processor 540 and the memory 570, which may include read-only memory (ROM) or flash memory (neither shown), and random access memory (RAM) (not shown), as previously noted. The RAM may include the main memory into which the operating system, development software, testing programs, and application programs are loaded. The ROM or flash memory can contain, among other code, the Basic Input-Output system (BIOS) which controls basic hardware operation such as the interaction with peripheral components. Applications resident with the computer 500 may be stored on and accessed via a computer readable medium, such as a hard disk drive (e.g., fixed storage 530), an optical drive, floppy disk, or other storage medium 550.

The fixed storage 530 can be integral with the computer 500 or can be separate and accessed through other interfaces. The fixed storage 530 may be part of a storage area network (SAN). A network interface 590 can provide a direct connection to a remote server via a telephone link, to the Internet via an internet service provider (ISP), or a direct connection to a remote server via a direct network link to the Internet via a POP (point of presence) or other technique. The network interface 590 can provide such connection using wireless techniques, including digital cellular telephone connection, Cellular Digital Packet Data (CDPD) connection, digital satellite data connection or the like. For example, the network interface 590 may enable the computer to communicate with other computers and/or storage devices via one or more local, wide-area, or other networks, as shown in FIGS. 3-4.

Many other devices or components (not shown) may be connected in a similar manner (e.g., data cache systems, application servers, communication network switches, firewall devices, authentication and/or authorization servers, computer and/or network security systems, and the like). Conversely, all the components shown in FIGS. 3-4 need not be present to practice the present disclosure. The components can be interconnected in different ways from that shown. Code to implement the present disclosure can be stored in computer-readable storage media such as one or more of the memory 570, fixed storage 530, removable media 550, or on a remote storage location.

FIG. 4 shows an example network arrangement according to an implementation of the disclosed subject matter. Four separate database systems 1200a-d at different nodes in the network represented by cloud 1202 communicate with each other through networking links 1204 and with users (not shown). The database systems 1200a-d may store, for example, data that has been transmitted in response to a request from one or more services, data to be transmitted in response to the request from one or more services, and the like. In some implementations, the one or more of the database systems 1200a-d may be located in different geographic locations. Each of database systems 1200 can be operable to host multiple instances of a database, where each instance is accessible only to users associated with a particular tenant. Each of the database systems can constitute a cluster of computers along with a storage area network (not shown), load balancers and backup servers along with firewalls, other security systems, and authentication systems. Some of the instances at any of database systems 1200a-d may be live or production instances processing and committing transactions received from users and/or developers, and/or from computing elements (not shown) for receiving and providing data for storage in the instances.

One or more of the database systems 1200a-d may include at least one storage device, such as in FIG. 4. For example, the storage can include memory 570, fixed storage 530, removable media 550, and/or a storage device included with the central component 600 and/or the second computer 700. The tenant can have tenant data stored in an immutable storage of the at least one storage device associated with a tenant identifier.

In some implementations, the one or more servers shown in FIGS. 3-4 can store the data (e.g., immediately available data to be transmitted, previously transmitted data, and the like) in the immutable storage of the at least one storage device (e.g., a storage device associated with central component 600, the second computer 700, and/or the database systems 1200a-1200d) using a log-structured merge tree data structure.

The systems and methods of the disclosed subject matter can be for single tenancy and/or multitenancy systems. Multitenancy systems can allow various tenants, which can be, for example, developers, users, groups of users, and/or organizations, to access their own records (e.g., tenant data and the like) on the server system through software tools or instances on the server system that can be shared among the various tenants. The contents of records for each tenant can be part of a database containing that tenant. Contents of records for multiple tenants can all be stored together within the same database, but each tenant can only be able to access contents of records which belong to, or were created by, that tenant. This may allow a database system to enable multitenancy without having to store each tenants' contents of records separately, for example, on separate servers or server systems. The database for a tenant can be, for example, a relational database, hierarchical database, or any other suitable database type. All records stored on the server system can be stored in any suitable structure, including, for example, a log structured merge (LSM) tree.

Further, a multitenant system can have various tenant instances on server systems distributed throughout a network with a computing system at each node. The live or production database instance of each tenant may have its transactions processed at one computer system. The computing system for processing the transactions of that instance may also process transactions of other instances for other tenants.

Some portions of the detailed description are presented in terms of diagrams or algorithms and symbolic representations of operations on data bits within a computer memory. These diagrams and algorithmic descriptions and representations are commonly used by those skilled in the data processing arts to most effectively convey the substance of their work to others skilled in the art. An algorithm is here and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers, or the like.

It should be borne in mind, however, that all these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” “processing,” “determining,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

More generally, various implementations of the presently disclosed subject matter can include or be implemented in the form of computer-implemented processes and apparatuses for practicing those processes. Implementations also can be implemented in the form of a computer program product having computer program code containing instructions implemented in non-transitory and/or tangible media, such as hard drives, solid state drives, USB (universal serial bus) drives, CD-ROMs, or any other machine readable storage medium, wherein, when the computer program code is loaded into and executed by a computer, the computer becomes an apparatus for practicing implementations of the disclosed subject matter. Implementations also can be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium can be implemented by a general-purpose processor, which can transform the general-purpose processor or a device containing the general-purpose processor into a special-purpose device configured to implement or carry out the instructions. Implementations can be implemented using hardware that can include a processor, such as a general purpose microprocessor and/or an Application Specific Integrated Circuit (ASIC) that implements all or part of the techniques according to implementations of the disclosed subject matter in hardware and/or firmware. The processor can be coupled to memory, such as RAM, ROM, flash memory, a hard disk or any other device capable of storing electronic information. The memory can store instructions adapted to be executed by the processor to perform the techniques according to implementations of the disclosed subject matter.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described to explain the principles of implementations of the disclosed subject matter and their practical applications, to thereby enable others skilled in the art to utilize those implementations as well as various implementations with various modifications as can be suited to the particular use contemplated.

1. A method comprising:
receiving, at a server, a request for data from a plurality of services;
receiving, at the server, a first portion of the data that is available from at least one of the plurality of services at a first time, and transmitting the received first portion of data via a communications network; and
receiving, at the server, a second portion of the data of the data that is newly available from at least one of the plurality of services at a second time that is different from the first time, and transmitting the received second portion of data via the communications network,
wherein the requested data from the plurality of services is provided in separate portions to be processed as the requested data becomes available.

2. The method of claim 1, wherein the transmitting the received second portion of data comprises transmitting the received first portion of data and the received second portion of data as part of the same response.

3. The method of claim 1, further comprising:
receiving, at a client device communicatively coupled to the communications network, at least one of the first portion of data and second portion of data; and
processing, at a processor of the client device, the received at least one of the first portion of data and second portion of data.

4. The method of claim 3, further comprising:
processing, at the processor of the client device, the received first portion of data before receiving the second portion of data.

5. The method of claim 3, further comprising:
determining, at the client device, when at least one of the first portion of data and second portion of data is delayed based on at least one selected form the group consisting of: a header, and at least one parameter.

6. A system comprising:
a communications network;
a server, communicatively coupled to the communications network, to receive a request for data from a plurality of services, to receive a first portion of the data that is available from at least one of the plurality of services at a first time and transmit the received first portion of data via the communications network, and receive a second portion of the data of the data that is newly available from at least one of the plurality of services at a second time that is different from a first time and transmit the received second portion of data via the communications network,
wherein the requested data from the plurality of services is provided in separate portions to be processed as the requested data becomes available.

7. The system of claim 6, wherein the server transmits the received second portion of data by transmitting the received first portion of data and the received second portion of data as part of the same response.

8. The system of claim 6, further comprising:
a client device including a processor to receive at least one of the first portion of data and second portion of data,
wherein received at least one of the first portion of data and second portion of data is processed by the processor.

9. The system of claim 8, wherein the processor of the client device processes the received first portion of data before receiving the second portion of data.

10. The system of claim 8, wherein the client device determines when at least one of the first portion of data and second portion of data is delayed based on at least one selected form the group consisting of: a header, and at least one parameter.
